(19) United States
(12) Patent Application Publication
(10) Pub. No.: US 2006/0005673 A1
(43) Pub. Date: Jan. 12, 2006

(54) Extendable chain saw system

(75) Inventors: Charles K. Long, Seneca, SC (US); Benjamin J. Thomas, Anderson, SC (US); Kenneth M. Brazell, Anderson, SC (US); Amy T. Brinckerhoff, Boca Raton, FL (US)

Correspondence Address: HARRINGTON & SMITH, LLP, 4 RESEARCH DRIVE, SHELTON, CT, 06484-6212, US

(73) Assignee: Homelite Technologies Ltd.

(21) Appl. No.: 10/889,546

(22) Filed: Jul. 12, 2004

(51) Int. Cl. B26D 1/00

(52) U.S. Cl. 83/13; 83/788

(57) ABSTRACT

A hand-held electric chain saw including a frame forming a housing with a rear end handle; a motor connected to the frame; a chain bar connected to the frame; a saw chain movably mounted to the chain bar and connected by a drive to the motor; and an extension pole attachment system on a bottom surface of the frame adapted to receive a portion of an extension pole to fixedly attach the extension pole to the bottom surface of the frame. The extension pole includes a pole section having a front end and a rear end; a removable connection system at the front end of the pole section; and an electrical cord. The removable connection system includes a rail adapted to slide into a slot at a bottom of the chain saw to thereby mechanically connect the extension pole to the chain saw.

### BACKGROUND OF THE INVENTION

1. Field of the Invention

The present invention relates to electric power tools and, more particularly, to an extendable power tool system having an extension pole.

2. Brief Description of Prior Developments

U.S. Pat. No. 5,884,403 discloses a telescoping pole assembly for an electric chain saw. There is a desire to provide an extension pole for an electric chain saw which is easier to attached to the chain saw than conventional extension poles. There is also a desire to provide a connection system between an extension pole and an electric chain saw which is relatively easy and quick to disconnect the two components from each other. There is also a desire to provide an extension pole for an electric chain saw which provides an easier connection system for allowing the chain saw to be actuated by a remote user actuated switch on a rear end of the extension pole.

### SUMMARY OF THE INVENTION

In accordance with one aspect of the present invention, a hand-held electric chain saw is provided comprising a frame forming a housing with a rear end handle; a motor connected to the frame; a chain bar connected to the frame; a saw chain movably mounted to the chain bar and connected by a drive to the motor; and an extension pole attachment system on a bottom surface of the frame adapted to receive a portion of an extension pole to fixedly attach the extension pole to the bottom surface of the frame.

In accordance with another aspect of the present invention, a hand-held electric chain saw is provided comprising a frame forming a housing; an electric motor connected to the frame; an electrical connector adapted to be coupled to a power source; a user actuated trigger switch connected to a rear end handle of the housing and adapted to supply electricity from the electrical connector to the motor; and an electrical bypass switch connected to the housing. The electrical bypass switch is adapted to electrically bypass the user actuated trigger switch to supply electricity from the electrical connector to the motor.

In accordance with another aspect of the present invention, a power tool extension pole is provided comprising a pole section having a front end and a rear end; a removable connection system at the front end of the pole section; and an electrical cord. The removable connection system comprises a rail adapted to slide into a slot at a bottom of a power tool to thereby mechanically connect the extension pole to the power tool. The electrical cord extends through the pole section and has an electrical connector proximate the front end of the pole section which is adapted to be removably connected to the power tool.

In accordance with one method of the present invention, a method of coupling an extension pole to an electric power tool is provided comprising sliding a track at a front end of the extension pole into a slot at a bottom of a housing of the electric power tool; and connecting an electrical connector of the extension pole to the electric power tool. The track slides generally parallel to a bottom surface of the bottom of the housing.

### BRIEF DESCRIPTION OF THE DRAWINGS

The foregoing aspects and other features of the present invention are explained in the following description, taken in connection with the accompanying drawings, wherein:

FIG. 1 is an elevational side view of a power tool assembly incorporating features of the present invention;

FIG. 2 is a partial, exploded perspective view of the power tool and extension pole of the assembly shown in FIG. 1;

FIG. 3 is a partial bottom plan view of the power tool shown in FIGS. 1 and 2;

FIG. 4 is a cross sectional view of a portion of the housing of the power tool shown in FIG. 3 and the front end of the extension pole shown in FIG. 2;

FIG. 5 is a block diagram showing two electrical paths in the power tool shown in FIGS. 1-3;

FIG. 6 is a partial perspective view of an alternate embodiment of a movable connection system between the two pole members of the extension pole shown in FIG. 1;

FIG. 7 is a partial perspective view of a tool assembly of an alternate embodiment of the present invention;

FIG. 8 is a rear end view of the chain saw tool shown in FIG. 7 with the mounting bracket attached, but without showing the rest of the extension pole;

FIG. 9 is a cross sectional view one portion of the tool assembly shown in FIG. 7;

FIG. 10 is an exploded perspective view of the portion of the tool assembly shown in FIG. 9;

FIG. 11 is a cross sectional view taken along line 11-11 in FIG. 9; and

FIG. 12 is a cross sectional view taken along line 12-12 in FIG. 11.

### DETAILED DESCRIPTION OF THE PREFERRED EMBODIMENTS

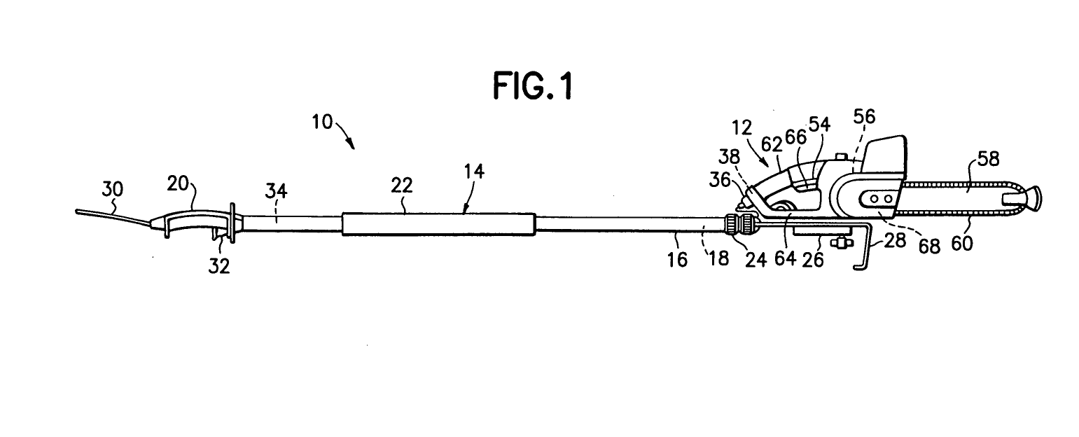

Referring to FIG. 1, there is shown an elevational side view of a power tool assembly 10 incorporating features of the present invention. Although the present invention will be described with reference to the exemplary embodiments shown in the drawings, it should be understood that the present invention can be embodied in many alternate forms of embodiments. In addition, any suitable size, shape or type of elements or materials could be used.

The power tool assembly 10 generally comprises a power tool 12 and an extension pole 14. In the embodiment shown, the power tool assembly 10 forms an extendable chain saw system. Specifically, the power tool 12 comprises an electric chain saw. However, in alternate embodiments, features of the present invention could be embodied in any suitable type of electric power tool, such as an electric hedge trimmer, for example. The extension pole 14 is an extendable extension pole. More specifically, the extension pole comprises telescoping pole members 16, 18 which can be slid relative to each other to lengthen or shorten the length of the extension pole 14. However, in an alternate embodiment, the extension pole might not be an extendable extension pole and could have a fixed length.

The extension pole 14 generally comprises the two pole members 16, 18, a rear end handle 20, a hand grip section 22, a rotatable friction collet 24, a removable connection system 26, and a front end having a limb hook 28. The two pole members 16, 18 forms a pole section for the extension pole. The pole members 16, 18 are preferably comprised of fiberglass. In an alternate embodiment, the pole section could be comprised of more than two pole members, such as three or more pole members. The second pole member 18 is slidably connected to the first pole member 16 inside the first pole member 16. The friction collet 24 is adapted to be rotated to stationarily fix the longitudinal position of the two pole members 16, 18 relative to each other. In an alternate embodiment, any suitable type of system for fixedly, but movably or adjustably locating the two pole members relative to each other could be provided.

The rear end handle 20 is fixedly attached to a rear end of the first pole member 16. An electrical cord 30 extends out of the handle 20 and preferably comprises an electrical plug (not shown) to be connected to an electrical extension cord or an electrical outlet (not shown). In an alternate embodiment, the handle 20 could comprise an electrical connector adapted to receive a socket of an electrical extension cord. The handle 20 comprises an electrical switch 32. The switch 32 comprises a user actuated trigger switch. The switch 32 is connected to the electrical cord 30 and an electrical cord 34 extending through the pole section.

The electrical cord 34 preferably comprises an extendable electrical cord, such as an electrical cord which is resiliently coiled inside the second pole member 18. In the embodiment in which the extension pole is not extendable, the electrical cord 34 does not need to be expandable. The electrical cord 34 extends out of a front end of the second pole member 18 and comprises an electrical connector 36. The electrical connector 36 is adapted to be removably connected to an electrical connector 38 at the rear end of the chain saw 12. The extension pole 14 is adapted to supply electricity to the chain saw 12 based upon whether the trigger switch 32 is depressed by a user. The trigger switch 32 could comprise any suitable safety interlock to prevent inadvertent actuation.

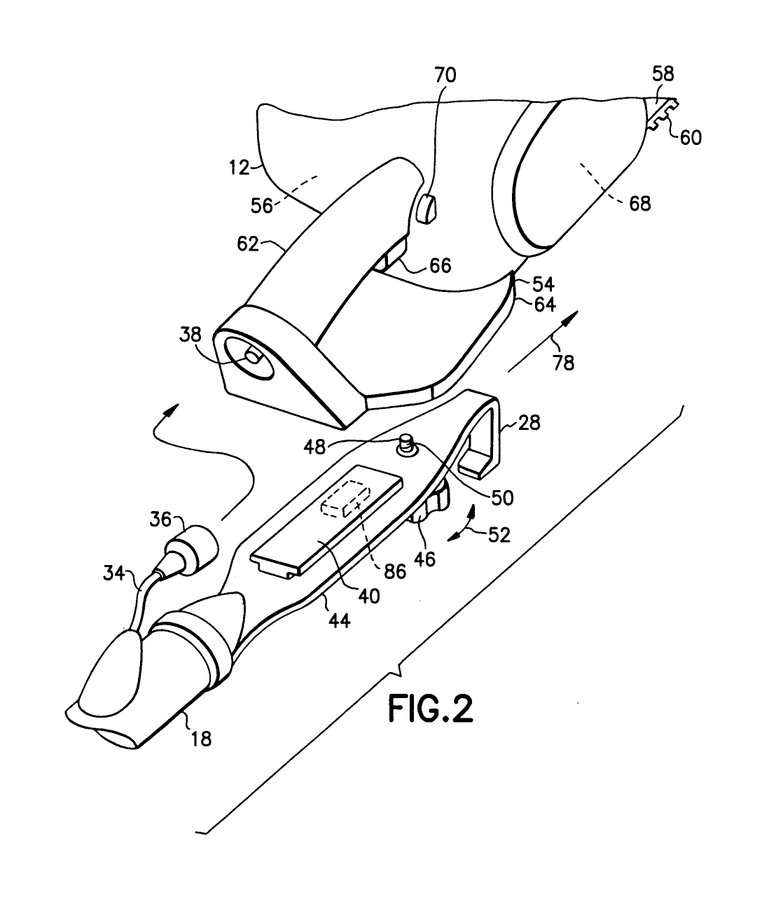

Referring also to FIGS. 2-4, the removable connection system 26 generally comprises a rail 40 and a tightening knob 42 at the front end 44 of the extension pole. The front end 44 is connected to the front end of the second extension pole 18. The rail 40 is located along a top side of the front end 44. In the embodiment shown, the rail 40 has a general T shaped cross section. The tightening knob 42 comprises a knob section 46 and a shaft section 48. The shaft section 48 extends through the front end 44. The tightening knob 42 is located at a bottom side of the front end 44 and is fixedly attached to the shaft section 48. The shaft section 48 is adapted to axially rotate. The shaft section 48 can slightly longitudinally move on the front end 44, but is preferably not removable from the front end (i.e., the shaft section is movably captured on the front end). The top end of the shaft section 48 comprises a threaded section 50. A user can rotate the knob section 46 as indicated by arrow 52 to rotate the threaded section 50 clockwise or counterclockwise.

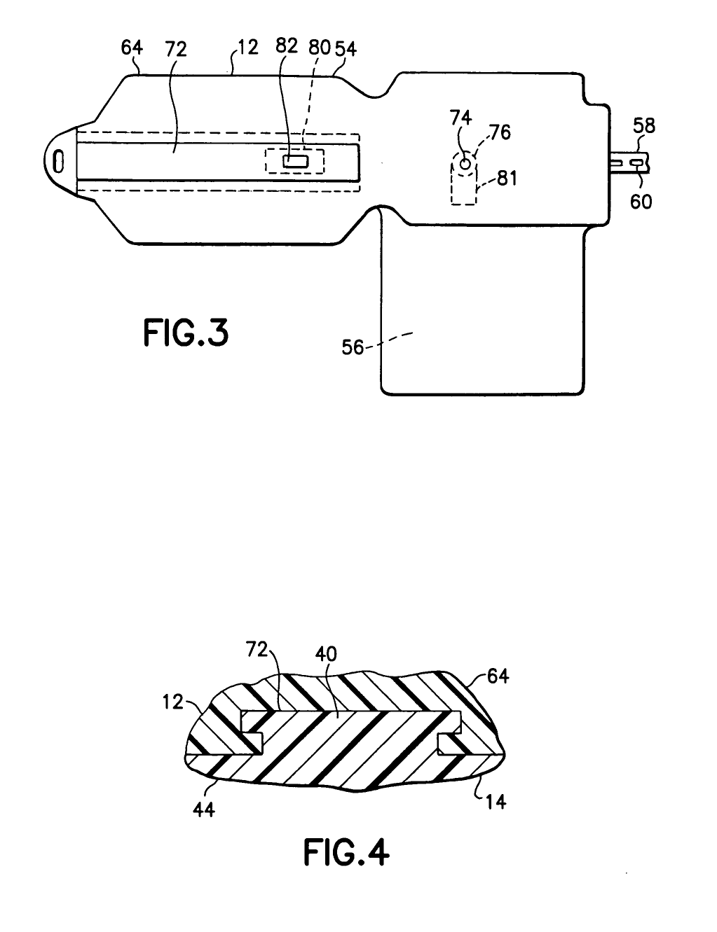

FIG. 3 shows a partial bottom plan view of the chain saw 12. As seen best in FIGS. 1 and 2, the chain saw 12 comprises a frame forming a housing 54, an electric motor 56, a chain bar 58 and a saw chain 60. The electric motor 56 is located inside the housing 54. A drive 68 is provided between the electric motor 56 and the saw chain 60 to drivingly rotate the saw chain 60 on the chain bar 58. The housing 54 forms a rear end handle 62. The electrical connector 38 is located at the rear end of the handle 62. A portion 64 of the housing 54 extends beneath the handle 62 and connects the rear end of the handle to the rest of the housing.

The chain saw 12 comprises a user actuated trigger switch 66. The trigger switch 66 is connected to the rear handle 62 at a front bottom side of the rear handle. The chain saw 12 can be operated without the extension pole 14. More specifically, an extension cord can be plugged into the electrical connector 38 and a user can depress the trigger switch 66 to actuate the chain saw. The chain saw 12 comprises an interlock button 70 to prevent the trigger switch 66 from being inadvertently depressed.

As seen in FIG. 3, the bottom side of the housing 54 comprises an extension pole attachment system. The extension pole attachment system generally comprises a slot 72 and a hole 74 having a threaded fastener 76 located in the hole. The slot 72 is located in the bottom surface of the housing portion 64 located beneath the rear end handle 62. As seen best in FIG. 4, the slot 72 comprises a general T shaped cross-section. The slot 72 is adapted to slidably received the rail 40 of the extension pole therein. The front end of the rail 40 can be slid into the rear end of the slot 72 as indicated by arrow 78. The track slides generally parallel to a bottom surface of the bottom of the housing. When the rail 40 reaches the front end of the slot 72, the shaft section 48 of the tightening knob 42 is located in registry with the hole 74 in the bottom side of the housing 54. A user can rotate the tightening knob while pressing the shaft section 48 into the hole 74. The threaded section 50 of the tightening knob can thread into the threaded fastener 76. Further rotation of the tightening knob causes the tightening knob 42 and the threaded fastener 76 to clamp the front end 44 against the bottom side of the housing 54 and, in conjunction with the rail 40 in the slot 72, fixedly and stationarily attach the front end 44 of the extension pole to the housing 54 of the chain saw 12. The electrical connector 36 can then be plugged into the electrical connector 38. One of the features of the present invention is the fact that the connection system provides a tool-less connection system. In other words, the connection system does not require the use of connection tools to connect and disconnect the power tool with the extension pole. This speeds up assembly and disassembly of the components. It also makes assembly and disassembly of the components easier than conventional types of systems.

In order to disassemble the extension pole from the chain saw, the user can merely reverse the process. The user can disconnect the electrical connector 36 from the electrical connector 38, rotate the tightening knob 42 to disconnect the threaded section 50 from the threaded fastener 76, and slide the front end 44 out of the slot 72 in a direction reverse to arrow 78.

As seen in FIG. 3, in the embodiment shown the chain saw 12 comprises an electrical bypass switch 80. The bypass switch 80 is separate and apart from the user actuated trigger switch 66. The bypass switch 80 comprises an actuator lever 82. The lever 82 extends into the slot 72. When the rail 40 is inserted into the slot 72, the rail 40 moves the lever 82 to thereby actuate the bypass switch 80. In an alternate embodiment, the power tool could have an additional or optional bypass switch 81 which is adapted to be actuated when the knob 42 of the extension pole is attached to the power tool. The act of tightening the knob 42 can mechanically actuate the secondary, bypass switch mounted internally in the chainsaw. The present invention allows the chain saw to be actuated without requiring a bracket to be mounted to the rear handle of the chain saw, and does not require the primary user actuated trigger switch of the chain saw to be locked on.

Referring also to FIG. 5, the chain saw 12 comprises an electrical system comprising the motor 56, the electrical connector 38, the user actuated trigger switch 66, and the bypass switch 80. Electricity can be supplied from the electrical connector 38 to the motor 56 by two paths 82, 84. The first path 82 is through the user actuated trigger switch 66. The second path 84 is through the bypass switch 80.

When the extension pole 14 is attached to the chain saw 12 and the bypass switch 80 is actuated by the rail 40 sliding into the slot 72, a user does not need to depress the user actuated trigger switch 66 to actuate the chain saw 12. Instead, in order to actuate the chain saw 12 a user needs to depress the user actuated trigger switch 32 at the rear end handle 20 of the extension pole 14. The bypass switch 80 is automatically actuated when the extension pole 14 is properly connected to the chain saw 12. Although the bypass switch 80 has been described above as comprising a lever which is moved by the rail 40, in an alternate embodiment the bypass switch 80 could comprise any suitable type of switch, such as a Reed switch activated by a magnet 86 (see FIG. 2) in the front end 44. In alternate embodiments, any suitable type of automatic bypass switch could be provided. In another type of alternate embodiment, the bypass switch might not be automatic, but could be a manual switch. One of the features of the present invention is the fact that the user actuated trigger switch 66 does not need to be moved or depressed by the extension pole 14. This allows for a connection system between the extension pole and the power tool which is easier and faster to connect and disconnect than conventional types of known systems.

Another feature of the present invention is the provision of the limb hook 28 on the front end 44 of the extension pole 14. When the extension pole is attached to the chain saw 12, the limb hook 28 is located beneath the chain saw, and is preferably behind the open saw chain 60. The limb hook 28 allows the front end 44 to be hooked onto a limb of a tree to temporarily rest of the assembly 10 on the tree limb. Location of the limb hook 28 beneath the chain saw and behind the open portion of the saw chain allows for easier positioning of the limb hook onto a tree limb and, easier removal of the limb hook from the tree limb with quicker initiation of cutting once the limb hook is moved off of the tree limb. In an alternate embodiment, the limb hook 28 might not be provided.

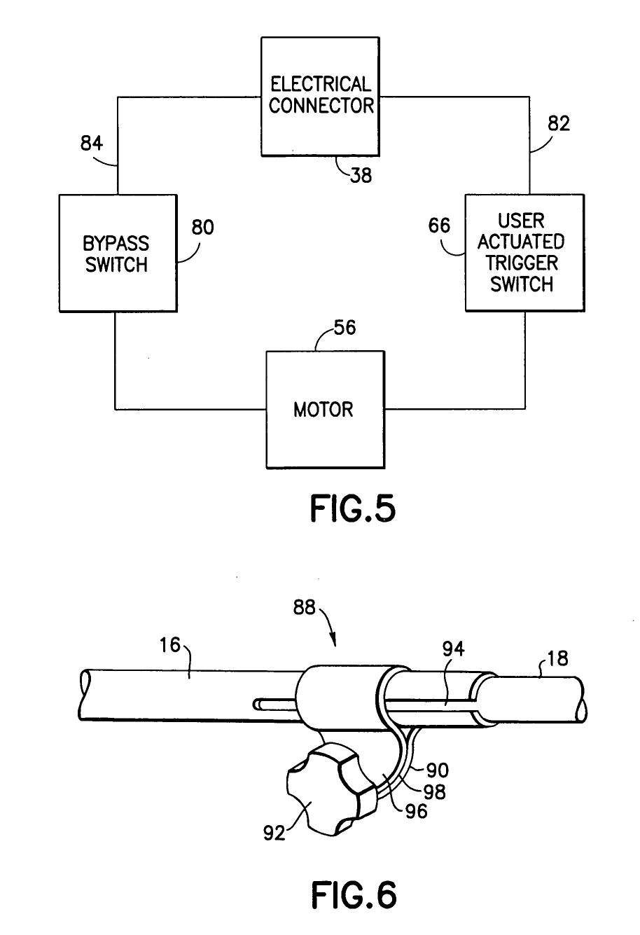

Referring now also to FIG. 6, an alternate embodiment of the coupling between the first and second pole members is shown. In this embodiment, the coupling 88 comprises a bracket 90 and a tightening knob 92. The front end of the first pole member 16 comprises a slot 94. The bracket 90 is located around the front end of the first pole member 16 and comprises two flanges 96, 98 which are located opposite each other. The tightening knob 92 is adapted to clamp the flanges 96, 98 against each other to thereby tighten the bracket 90 on the front end of the first pole member 16. As the bracket 90 is tightened onto the first pole member 16, the front end of the first pole member 16 is compressed onto the second pole member 18 with the slot 94 being reduced. This forms a friction grip between the front end of the first pole member 16 and the second pole member 18. The tightening knob 92 can be loosened to allow the second pole member 18 to longitudinally slide relative to the first pole member 16. As noted above, in alternate embodiments, any suitable type of movable, but stationarily fixable connection system between the pole members could be provided.

In an alternate embodiment, the front end of the extension pole could comprise multiple projections adapted to be received into multiple slots in the power tool housing, similar to a multiple scabbard attachment system. In one type of alternate embodiment of the present invention, the front end of the extension pole could comprise a longitudinal slot or slots, and the housing or frame of the power tool could comprise one or more projections or rails adapted to extend into the slot(s) to attach the extension pole to the power tool.

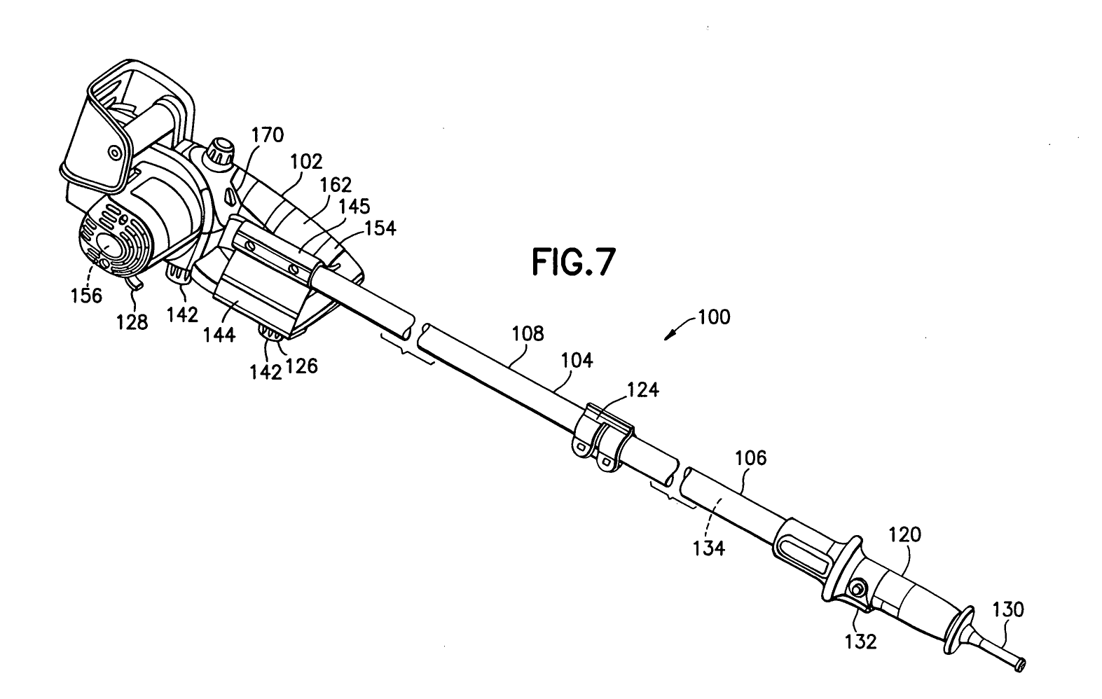

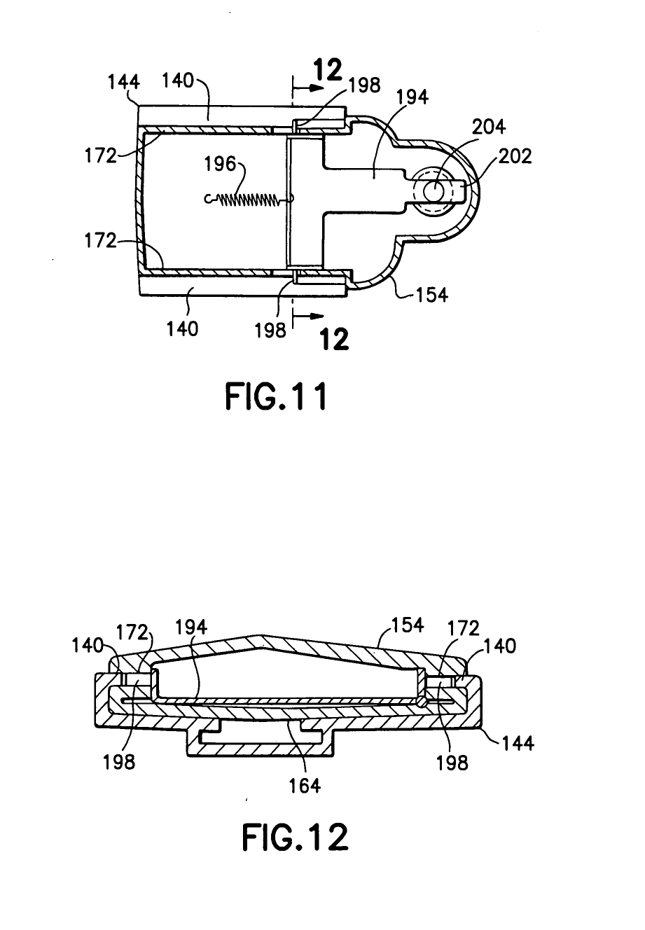

Referring now to FIGS. 7-12 an alternate embodiment of the present invention is shown. The tool assembly 100 generally comprises a power tool 102 and an extension pole 104. The power tool 102 comprises an electric chain saw. The extension pole 104 generally comprises the two pole members 106, 108, a rear end handle 120, a friction clamp 124, a removable connection system 126, and a front end having a limb hook 128. The two pole members 106, 108 forms a pole section for the extension pole. The pole members 106, 108 are preferably comprised of fiberglass. In an alternate embodiment, the pole section could be comprised of more or less than two pole members, such as three or more pole members. The second pole member 108 is slidably connected to the first pole member 106 inside the first pole member 106. The friction clamp 124 is adapted to stationarily fix the longitudinal position of the two pole members 106, 108 relative to each other. In an alternate embodiment, any suitable type of system for fixedly, but movably or adjustably locating the two pole members relative to each other could be provided.

The rear end handle 120 is fixedly attached to a rear end of the first pole member 106. An electrical cord 130 extends out of the handle 120 and preferably comprises an electrical plug (not shown) to be connected to an electrical extension cord or an electrical outlet (not shown). In an alternate embodiment, the handle 120 could comprise an electrical connector adapted to receive a socket of an electrical extension cord. The handle 120 comprises an electrical switch 132. The switch 132 comprises a user actuated trigger switch. The switch 132 is connected to the electrical cord 130 and an electrical cord 134 extending through the pole section.

The electrical cord 134 preferably comprises an extendable electrical cord, such as an electrical cord which is resiliently coiled inside the second pole member 108. In the embodiment in which the extension pole is not extendable, the electrical cord 134 does not need to be expandable. The electrical cord 134 extends out of a front end of the second pole member 108 and comprises an electrical connector (not shown). The electrical connector is adapted to be removably connected to an electrical connector 138 at the rear end of the chain saw 102. The extension pole 104 is adapted to supply electricity to the chain saw 102 based upon whether the trigger switch 132 is depressed by a user. The trigger switch 132 could comprise any suitable safety interlock to prevent inadvertent actuation.

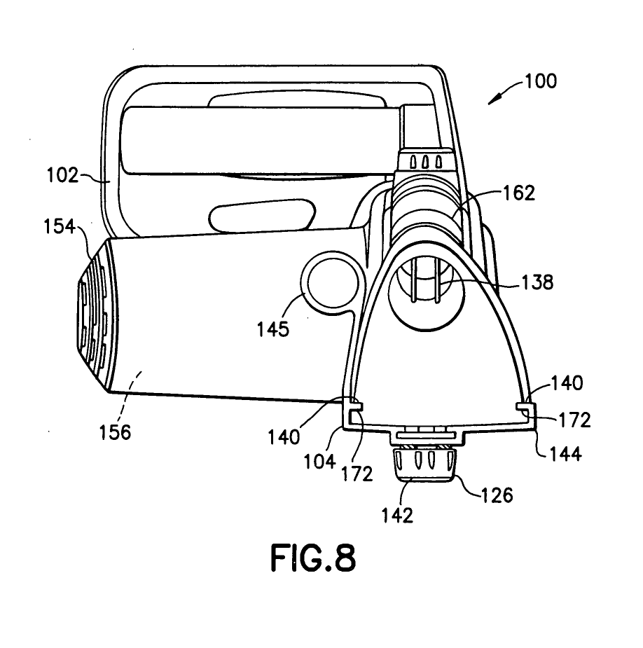

As seen best in FIGS. 8-10, the removable connection system 126 generally comprises a mounting bracket 144 having rails 140 and a two tightening knobs 142 at the front end of the extension pole. The mounting bracket 144 is connected to the front end of the second extension pole 108 at a lateral side tube section 145. The tube section 145 is preferably aligned with the right/left center of gravity of the chain saw 102. Thus, no gravitational twisting torque is exerted on the pole.

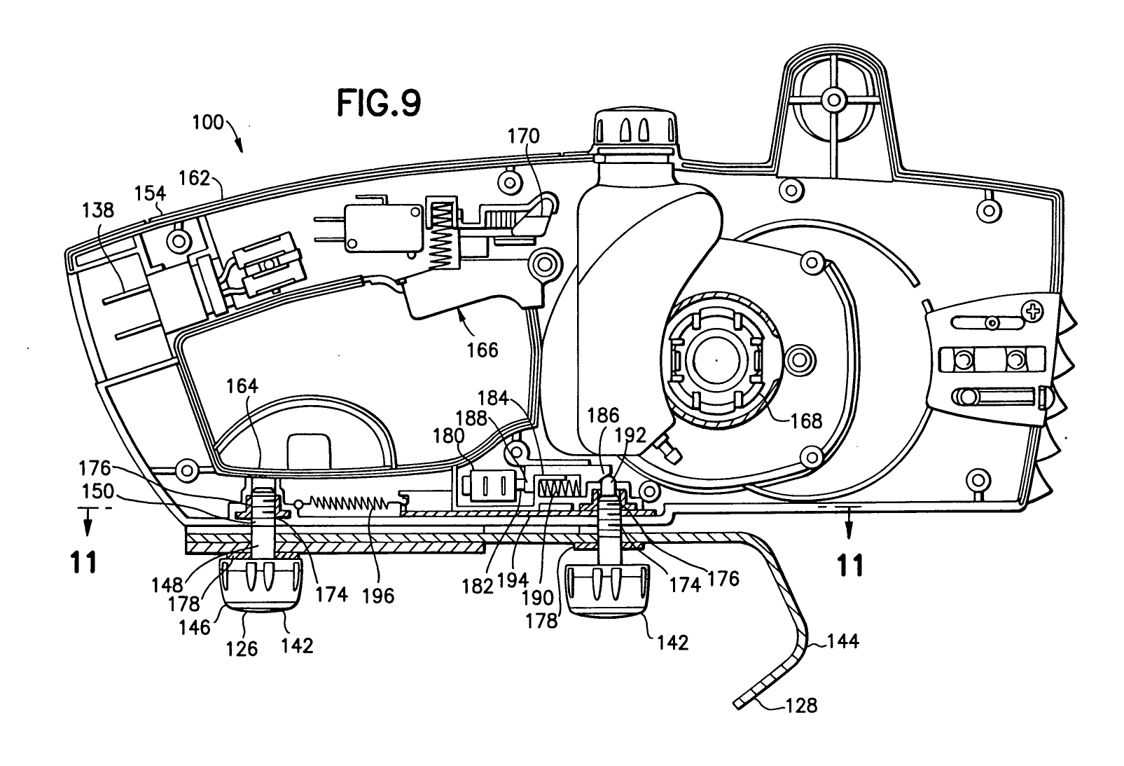

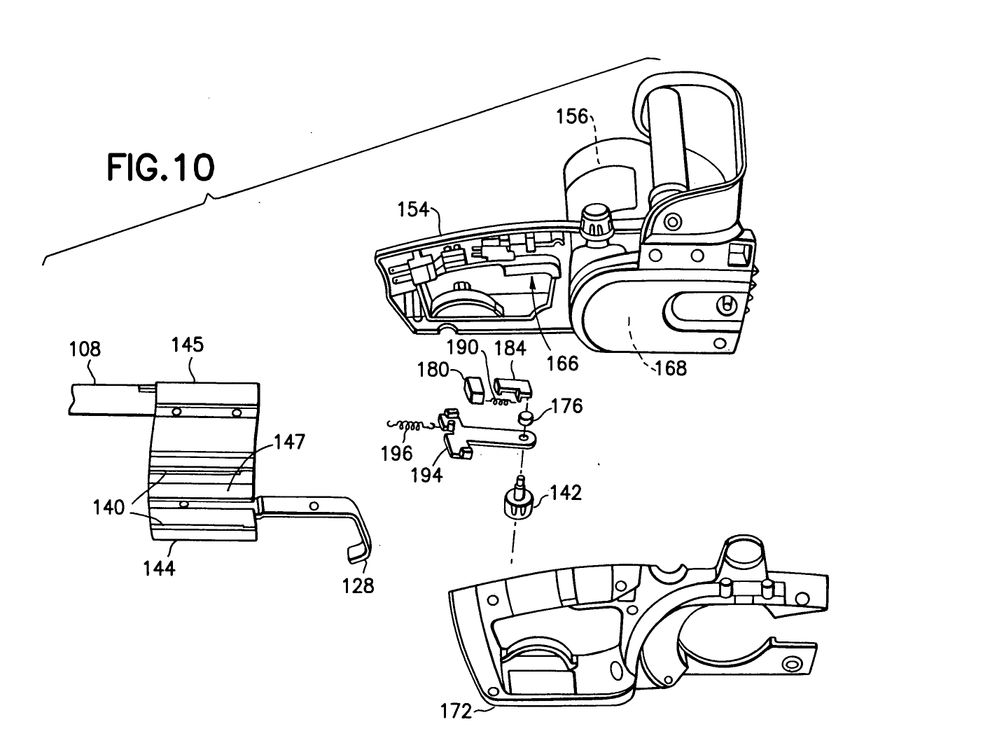

The rails 140 are located along sides of the mounting bracket 144 and project inward towards each other and form a receiving area 147 (see FIG. 10) therebetween. As seen in FIG. 9, the tightening knobs 142 each comprise a knob section 146 and a shaft section 148. The shaft section 148 extends through the mounting bracket 144. The knob section 146 is located at a bottom side of the mounting bracket 144 and is fixedly attached to the shaft section 148. The shaft section 148 is adapted to axially rotate. The shaft section 148 can slightly longitudinally move on the mounting bracket 144, but is preferably not removable from the front end (i.e., the shaft section is movably captured on the front end) such as by the use of lock washers 178. The top end of the shaft section 148 comprises a threaded section 150. A user can rotate the knob section 146 to rotate the threaded section 150 clockwise or counterclockwise.

As seen best in FIG. 10, the chain saw 102 comprises a frame forming a housing 154, an electric motor 156, a chain bar 158 and a saw chain 160. The electric motor 156 is located inside the housing 154. A drive 168 is provided between the electric motor 156 and the saw chain 160 to drivingly rotate the saw chain 160 on the chain bar 158. The housing 154 forms a rear end handle 162. The electrical connector 138 is located at the rear end of the handle 162. A portion 164 of the housing 154 extends beneath the handle 162 and connects the rear end of the handle to the rest of the housing.

As seen in FIGS. 9 and 10, the chain saw 102 comprises a user actuated trigger switch 166. The trigger switch 166 is connected to the rear handle 162 at a front bottom side of the rear handle. The chain saw 102 can be operated without the extension pole 104. More specifically, an extension cord can be plugged into the electrical connector 138 and a user can depress the trigger of the trigger switch 166 to actuate the chain saw. The chain saw 102 comprises an interlock button 170 (see FIGS. 7 and 9) to prevent the trigger switch 166 from being inadvertently depressed.

The bottom side of the housing 154 comprises an extension pole attachment system. The extension pole attachment system generally comprises two slots 172 and a two holes 174 having threaded fasteners 176 located in or behind the holes. The slots 172 are located in the lateral sides of the bottom of the housing portion 164 located beneath the rear end handle 162. The slots 172 are adapted to slidably received the rails 140 of the extension pole therein. The front end of the rails 140 can be slid into the rear end of the slots 172.

The rails slide generally parallel to a bottom surface of the bottom of the housing. When the rails 140 reach the front end of the slots 172, the shaft sections 148 of the tightening knobs 142 are located in registry with the holes 174 in the bottom side of the housing 154. A user can rotate the tightening knobs while pressing the shaft sections 148 into the holes 174. The threaded sections 150 of the tightening knobs can thread into the threaded fasteners 176. Further rotation of the tightening knobs causes the tightening knobs 142 and the threaded fasteners 176 to clamp the mounting bracket 144 against the bottom side of the housing 154 and, in conjunction with the rails 140 in the slots 172, fixedly and stationarily attach the mounting bracket 144 of the extension pole to the housing 154 of the chain saw 102. The electrical connector (not shown) of the extension pole can be plugged into the electrical connector 138.

In order to disassemble the extension pole from the chain saw, the user can merely reverse the process. The user can disconnect the pole's electrical connector from the electrical connector 138, rotate the tightening knobs 142 to disconnect the threaded sections 150 from the threaded fasteners 176, and slide the mounting bracket 144 out of the slots 172.

As seem in FIGS. 9-10, the chain saw 102 comprises an electrical bypass system which comprises an electrical bypass switch 180. The chain saw 102 comprises an electrical system comprising the motor 156, the electrical connector 138, the user actuated trigger switch 166, and the bypass switch 180. Electricity can be supplied from the electrical connector 138 to the motor 156 by two paths. The first path is through the user actuated trigger switch 166. The second path is through the bypass switch 180. The bypass switch 180 is separate and apart from the user actuated trigger switch 166. The bypass switch 180 comprises an actuator button 182. The bypass switch 180 can be actuated by slide block 184. The slide block 184 is slidably mounted in the housing 154. The slide block 184 has a front end with a cam surface 186 and a rear end with a button contact surface 188. The slide block 184 is biased by a spring 190 towards a forward position.

The front knob 142 has an extension 192 at the end of its shaft section. When the front knob 142 is screwed into the front fastener 176, the extension 192 is adapted to contact the cam surface 186 and cam the slide block 184 rearward. This causes the button contact surface 188 to actuate the bypass switch 180. Thus, the act of tightening the front knob 142 can mechanically actuate the bypass switch. The present invention does not require the primary user actuated trigger switch 166 of the chain saw to be locked ON. When the front knob is unscrewed, the spring 190 can return the slide block 184 to its forward position and the bypass switch 180 becomes deactivated.

When the extension pole 104 is attached to the chain saw 102 and the bypass switch 180 is actuated by the slide block 184 moved by the front knob, a user does not need to depress the user actuated trigger switch 166 to actuate the chain saw 102. Instead, in order to actuate the chain saw 102 a user needs to depress the user actuated trigger switch 132 at the rear end handle 120 of the extension pole 104. The bypass switch 180 is automatically actuated when the extension pole 104 is properly connected to the chain saw 102.

Although the bypass switch 180 has been described above as comprising a plunger moved by a cam which is moved by the fastener, in an alternate embodiment the bypass switch 180 could comprise any suitable type of switch. In alternate embodiments, any suitable type of automatic bypass switch could be provided. In another type of alternate embodiment, the bypass switch might not be automatic, but could be a manual switch. One of the features of the present invention is the fact that the user actuated trigger switch 166 does not need to be moved or depressed by the extension pole 104. This allows for a connection system between the extension pole and the power tool which is easier and faster to connect and disconnect than conventional types of known systems.

In the embodiment shown, the chain saw 102 comprises a cover to cover the front hole 174 and prevent debris from clogging access to, or actuating movement of, the slide block 184. As seen best in FIGS. 9, 11 and 12, the cover comprises a plate 194 and a spring 196. The plate 194 is slidably mounted to the housing 154 between a forward position and a rearward position. The spring 196 biases the plate 194 is a rearward position. The plate 194 has side projections 198 which are adapted to be contacted by front recessed ledges 200 of the rails 140 when the mounting bracket 144 is slide forward on the housing. The mounting bracket 144 is, thus, able to move the plate 194 from its rearward position to its forward position. When the mounting bracket 144 is removed, the spring 196 is able to return the plate 194 back to its rearward position.

The plate 194 has a front section 202 with a hole 204. When the plate 194 is in its forward position, the hole 204 is aligned with the front hole 174. Thus, the shaft section of the front knob passes through the hole 204 into the front fastener 176. When the plate 194 is in its rearward position, such as when the bracket 144 is not mounted to the chain saw 102, the plate's hole 204 is not in alignment with the front hole 174. Thus, the front section 202 of the plate 194 closes access to the front fastener 176 and the slide block 184 from the front hole 174.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A hand-held electric chain saw comprising a frame forming a housing with a rear end handle; a motor connected to the frame; a chain bar connected to the frame; a saw chain movably mounted to the chain bar and connected by a drive to the motor; and an extension pole attachment system on a bottom of the frame adapted to receive a portion of an extension pole to fixedly attach the extension pole to the bottom of the frame.

2. A hand-held electric chain saw as in claim 1 wherein the extension pole attachment system comprises a slot in the housing beneath the rear end handle.

3. A hand-held electric chain saw as in claim 1 wherein the bottom of the frame comprises a threaded fastener adapted to receive a portion of a tightening knob of the extension pole.

4. A hand-held electric chain saw as in claim 3 further comprising an electrical trigger bypass switch and a cam, the cam being adapted to actuate the electrical trigger bypass switch when the tightening knob is attached to the bottom of the frame.

5. A hand-held electric chain saw as in claim 1 further comprising a user actuated trigger switch connected to the rear end handle and an electrical bypass switch located proximate the bottom of the frame.

6. A hand-held electric chain saw as in claim 5 wherein the electrical bypass switch is adapted to be automatically actuated when the extension pole is attached to the extension pole attachment system.

7. An extendable chain saw system comprising:
a hand-held electric chain saw as in claim 1; and
a power tool extension pole removably attached to the bottom of the housing of the chain saw.

8. An extendable chain saw system as in claim 7 wherein the extension pole attachment system of the chain saw comprises a slot in the housing beneath the rear end handle, and wherein the extension pole comprises a removable connection system at a front end of a pole section, the removable connection system comprising a rail which is slid into the slot in the housing.

9. An extendable chain saw system as in claim 7 the chain saw further comprising a user actuated trigger switch connected to the rear end handle and an electrical bypass switch located proximate the bottom of the frame, and wherein the electrical bypass switch is adapted to be automatically actuated when the extension pole is attached to the extension pole attachment system.

10. An extendable chain saw system as in claim 7 wherein the power tool extension pole comprises a front end with a limb hook located beneath the chain saw adapted to hook the front end of the extension pole onto a limb of a tree.

11. An extendable chain saw system as in claim 7 wherein the power tool extension pole comprises a rotatable tightening knob which is threaded into a threaded fastener at a bottom of the chain saw housing.

12. An extendable chain saw system as in claim 7 wherein the power tool extension pole comprises an electrical cord extending through a pole section of the extension pole, the electrical cord comprising an electrical connector removably attached to the electric chain saw.

13. An extendable chain saw system as in claim 7 wherein the power tool extension pole comprises a telescoping pole section, an adjustable length electric cord extending through the pole section, and a user actuated trigger switch at a rear end of the pole section coupled to the adjustable length electric cord.

14. A hand-held electric chain saw comprising:
a frame forming a housing;
an electric motor connected to the frame;
an electrical connector adapted to be coupled to a power source;
a user actuated trigger switch connected to a rear end handle of the housing and adapted to supply electricity from the electrical connector to the motor; and
an electrical bypass switch connected to the housing, the electrical bypass switch being adapted to electrically bypass the user actuated trigger switch to supply electricity from the electrical connector to the motor.

15. A hand-held electric chain saw as in claim 14 wherein the electrical bypass switch comprises a lever adapted to be moved by a portion of an extension pole when the extension pole is attached to the housing.

16. A hand-held electric chain saw as in claim 14 wherein the electrical bypass switch comprises a Reed switch which is adapted to be actuated by a magnet on an extension pole when the extension pole is attached to the housing.

17. A hand-held electric chain saw as in claim 14 further comprising an extension pole attachment system at a bottom of the housing which is adapted to receive a portion of an extension pole to fixedly attach the extension pole against a bottom surface of the housing, wherein the extension pole attachment system comprises a slot along a bottom of the housing.

18. A power tool extension pole comprising:
a pole section having a front end and a rear end;
a removable connection system at the front end of the pole section, wherein the removable connection system comprises a rail adapted to slide into a slot at a bottom of a power tool to thereby mechanically connect the extension pole to the power tool; and
an electrical cord extending through the pole section having an electrical connector proximate the front end of the pole section which is adapted to be removably connected to the power tool.

19. A power tool extension pole as in claim 18 wherein a front end of the removable connection system comprises a limb hook adapted to be located under the power tool and hook the front end of the extension pole onto a limb of a tree.

20. A power tool extension pole as in claim 18 wherein the removable connection system comprises a rotatable tightening knob which is threaded into a threaded fastener at a bottom of the power tool.

21. A power tool extension pole as in claim 18 wherein the pole section comprises telescoping pole members, wherein a length of the electric cord is adjustable and extends through the telescoping pole members, and further comprises a user actuated trigger switch at the rear end of the pole section coupled to the adjustable length electric cord.

22. A method of coupling an extension pole to an electric power tool comprising:
sliding a track at a front end of the extension pole into a slot at a bottom of a housing of the electric power tool, the track sliding generally parallel to a bottom surface of the bottom of the housing; and
connecting an electrical connector of the extension pole to the electric power tool.

23. A method as in claim 22 further comprising actuating a bypass switch in the electric power tool when the extension pole is slid into the housing of the electric power tool to electrically bypass a user actuated trigger switch of the electric power tool.

24. A method as in claim 22 further comprising actuating a trigger bypass switch in the electric power tool when a tightening knob of the extension pole is screwed into the housing.
